(19) United States
(12) Patent Application Publication
(10) Pub. No.: US 2015/0146297 A1
(43) Pub. Date: May 28, 2015

(54) SECURITY DEVICES AND METHODS OF MANUFACTURE THEREFOR

(71) Applicant: DE LA RUE INTERNATIONAL LIMITED, Basingstoke, Hampshire (GB)

(72) Inventors: Lawrence George Commander, Reading (GB); Matthew Sugdon, East Yorkshire (GB); Stephen Banister Green, Southampton (GB)

(21) Appl. No.: 14/400,051

(22) PCT Filed: May 8, 2013
(86) PCT No.: PCT/GB2013/051188

§ 371 Date: Nov. 10, 2014

Related U.S. Application Data
(60) Provisional application No. 61/645,242, filed on May 10, 2012.

(30) Foreign Application Priority Data
May 10, 2012 (GB) 1208137.8

(51) Int. Cl. B42D 25/30; G02B 3/00

(52) U.S. Cl. CPC B42D 25/30; G02B 3/0006; G02B 3/0031
USPC 359/627; 359/619; 427/7

(57) ABSTRACT

An aspect of the invention provides a security device including an array of printed lenses arranged on a first surface of a substrate and a microimage array underlying the array of printed lenses, whereby a synthetic image of portions of the microimages is generated by the lenses. The security device further comprises at least one tactile element arranged on the first surface of the substrate which is of greater or lesser height than the printed lenses, the at least one tactile element being registered to the array of printed lenses.

This invention relates to security devices for use on objects of value such as security documents, including currency, passports, identification documents, identification cards, credit cards and the like, as well as methods for the manufacture of the security devices.

Security documents such as ID cards are frequently the target of counterfeiters who seek to produce an imitation document to be passed off as authentic, or to manipulate the data on an authentic document, e.g. for use by a person different to that originally intended. To deter this, security documents are typically provided with one or more security devices for checking the authenticity of the document. Examples include features based on one or more patterns such as microtext, fine line patterns, latent images, venetian blind devices, lenticular devices, moiré interference devices and moiré magnification devices, each of which generates a secure visual effect. Other known security devices include holograms, watermarks, embossings, perforations and the use of colour-shifting or luminescent/fluorescent inks. To be effective as a security device, the feature should be difficult or impossible to reproduce by conventional copying means (e.g. photocopying) and not easily imitated through readily available means such as conventional ink-jet or laser printers.

One class of security device that has been found effective is lens-based devices, which typically incorporate an array of lenses (e.g. spherical or cylindrical) formed on a transparent sheet in combination with an array of microimages positioned in or around the focal plane of the lenses. Depending on the arrangement of lenses and microimages, various different effects can be achieved. For instance, in a lenticular device, different sections of the microimages are imaged by the lenses depending on the viewing angle of the device such that as the device is tiled, different microimages are viewed in the form of a synthetic (preferably focussed) image. This can be used to create a device whose appearance “switches” as the viewing angle is changed, or if more than two different sets of microimages are provided, an animated appearance can be attained. Further details and examples of lenticular devices are given in our International application WO-A-2011051670.

Another lens-based device is the moiré magnifier, in which a mismatch between either the pitches of the lens and image arrays, or the angle between them (or both) is introduced. In this way, each lens picks up a different portion of the underlying microimage, with the result being a synthetic, magnified image of the microimages. Examples of moiré magnification devices and effects that can be achieved are described in EP-A-0698256, WO-A-2005106601 and in our International Patent Application No. PCT/GB2011/050398.

Further examples of security devices incorporating lens arrays are disclosed in WO-A-2007/087984 and US-A-2011/0248492.

Conventionally, lens arrays suitable for forming lens-based security devices such as those described above are formed by moulding the lenses into the surface of a transparent sheet, or by casting the lenses into a radiation curable resin. The microimages can then be applied to the opposite surface, e.g. by printing. However, it is also possible to form the lens array by printing a suitable transparent material on to a substrate, as described in U.S. Pat. No. 7,609,451 and US-A-2011/0116152. The material is configured to “bead up” on contact with the substrate surface, forming the desired lens profile.

Whilst lens-based devices such as those described do produce strong visual effects, there is a constant need to improve the security level of security devices to stay ahead of potential counterfeiters. In particular, moulded or cast lenticular lens arrays are increasingly becoming more widely available, e.g. for decorative uses, which can be used by counterfeiters to produce more accurate imitation devices than previously possible. It would be desirable to provide a security device which achieves the same strong visual effects yet poses a greater obstacle to would-be copyists.

In accordance with a first aspect of the present invention, a security device is provided comprising an array of printed lenses arranged on a first surface of a substrate and a microimage array underlying the array of printed lenses and disposed in the focal plane of the lenses, whereby a synthetic image of portions of the microimages is generated by the lenses, the security device further comprising at least one tactile element arranged on the first surface of the substrate which is of greater or lesser height than the printed lenses, the at least one tactile element being registered to the array of printed lenses and/or to the microimage array.

By combining a lens-based security feature (e.g. a lenticular device, moiré-magnifier or other visual effect) with at least one tactile element on the same surface and in register with one another, the difficulty of counterfeiting the device is substantially enhanced. Rarely can a counterfeiter successfully forge all security features and, by integrating different security effects in this way, that failure is made more obvious in a counterfeit device. Tactile elements provide the particular advantage that the additional secure effect they contribute is not visual but rather detectable to the touch. As such, tactile elements impose minimal restrictions on the visual appearance of the device such that the strong visual effect of the lens-based device is not compromised. By registering the tactile element(s) to the synthetic image generated by the lens-based device, i.e. requiring the tactile element(s) to have a particular and exact location relative to the lenses and/or microimages which is reproduced in all of the devices (e.g. a series of such devices), the bar is significantly raised to the counterfeiter since this cannot be achieved where the lenses, microimages and tactile feature are produced in two or more entirely separate manufacturing processes, which must be the case where a pre-formed moulded or cast array of lenses is utilised (since this will not include any tactile elements, and hence these must be added separately).

Preferably, the at least one tactile element comprises an area of the substrate in which no operative printed lenses are present. That is, no lenses which are capable of diffracting light in the required manner to generate a synthetic image are present and hence there is no generation of such an image in the locality of the at least one tactile element. For instance, no elements which focus light from the plane in which the microimage array sits are present. The tactile element therefore appears as an interruption in the synthetic image. Operative lenses may be absent due to the omission of lenses from the lens array in the relevant area or such lenses could be present but have their function disabled, e.g. due to their being coated with a material of similar refractive index such that the light-diffracting shape is effectively lost (the lenses are “indexed-out”). This disabling coating could be used to form the tactile elements, as described below.

The “height” of the lenses and tactile element(s) refers to their maximum height relative to the first surface of the substrate (which is preferably substantially flat, e.g. planar). Typically all of the lenses in the array will have approximately the same height but, if this is not the case, the relevant height is the average height of the lenses. The tactile element(s) can be positive (i.e. raised relative to the lenses), or negative (i.e. recessed relative to the lenses), or can comprise a mixture of both positive and negative elements. For instance, in one preferred example, the at least one tactile element comprises an area of the substrate in which the printed lenses are absent, which area is defined on at least two sides by the array of printed lenses. This is an example of a negative tactile element whose presence is detectable by touch due to the “gap” it presents between the lenses.

In another advantageous example, the at least one tactile element comprises an area of the substrate on which is disposed material, the height of which defines the height of the tactile element. This technique can be used to form a positive or negative tactile element. As detailed below, the material may be disposed on top of the lenses (in which case a positive tactile element will be formed), or on an area of the substrate without lenses (in which case a positive or negative tactile element may be formed, depending on the height of material deposited).

In particularly preferred implementations, the at least one tactile element is a printed tactile element, preferably deposited by means of the same printing technique as that by which the array of lenses is printed. By forming the tactile element(s) using a printing technique, a very high level of registration between the lenses and the tactile elements can be achieved since the lenses and tactile elements can be applied to the substrate in-line (during the same print run) or even simultaneous as part of a single printing operation.

Thus in many cases it is preferred that the array of printed lenses and the at least one printed tactile element form part of the same printed working. This ensures 100% registration between the lenses and the tactile element(s). However, in other preferred examples, the array of printed lenses forms part of a printed lens working and the at least one printed tactile element forms part of a printed tactile working. Such techniques can still achieve a very high level of registration, particularly if the same printing method is utilised for each working. The two workings could be laid down in either order, but preferably, the printed lens working underlies the printed tactile working.

The lens array could be continuous over at least a portion of the device with the tactile element(s) deposited on top. However, in some preferred embodiments, the printed lens working comprises at least one area in which no lenses are present, and the printed tactile working comprises at least one tactile element located in the at least one area. This allows for a greater range of tactile element heights. Where the lenses are absent, no synthetic image of the microimages will be generated and hence the tactile feature appears as a “negative” or ghost image against the synthetic image.

In further preferred embodiments, the printed tactile working includes at least one tactile element located over one or more the printed lenses. This may be desirable where a greater height of the tactile element is desired. The material forming the tactile element covers the lenses and so prevents the generation of a synthetic image in this area (this remains the case if the material is transparent since the operative shape of the lenses will be destroyed by the deposited material, such that the tactile element once again appears as a “negative” or ghost image).

Preferably, the at least one tactile element has a height which differs from that of the lenses by at least 5 microns, preferably at least 10 microns. In advantageous embodiments, the lenses have a height in the range 5 to 15 microns, preferably around 8 to 12 microns. For positive tactile elements, preferably the at least one tactile element has a height of at least 15 microns, more preferably at least 20 microns. In particularly preferred embodiments, the at least one tactile element has a height at least twice that of the lenses.

The lateral size of the tactile element(s) may also influence their effectiveness. For example, if a negative tactile element is too narrow, it may be difficult to detect by touch. Conversely, if a tactile element is too wide, a large portion of the visual effect generated by the lens-based feature may be obliterated. Hence in preferred cases, the at least one tactile element has a width (e.g. linewidth) of between 100 microns and 5 millimetres, preferably between 250 microns and 3 millimetres, more preferably between 500 microns and 2 millimetres. Tactile effects can be enhanced by repeating lines so as to make the sensation more distinctive. In preferred examples, lines would be repeated 3 to 7 times in a regular pattern.

The tactile element(s) could take any form which may or may not relate to the visual effects generated by the lens-based feature. However, for an further increased security level, the tactile element(s) are preferably configured such that their shape and/or location is directly related to the visual effects. This assists the user in determining where the tactile feature(s) should be found and hence identifying counterfeits. This can be achieved in a number of ways. In one preferred embodiment, the array of lenses and microimage array are configured such that in a first region of the device, a first synthetic image is generated and in a second region of the device, laterally offset from the first region, a different visual appearance is exhibited, the at least one tactile element including a tactile element disposed at a boundary between the first and second regions. Thus the tactile element is located at a clearly defined position related to the visual effect. If the tactile element is displaced from the boundary, this will be obvious upon inspection since the element will be felt at a position which does not coincide with the visible boundary.

In particularly preferred cases, the at least one tactile element is elongate and disposed along at least a portion of the boundary between the first and second regions, preferably along the full length of the boundary. For instance, the element(s) may form an outline of one or both of the first and second regions. This clearly defines the intended position of the tactile element(s).

The two regions could each be configured to exhibit a visual effect. However, in certain embodiments, in the second region, there are no lenses and/or no microimages, such that no synthetic image is generated, whereby the at least one tactile element defines the perimeter of the region generating the first synthetic image. In this case, the tactile element is preferably a positive tactile element.

In particularly preferred examples, in the second region, the array of lenses and/or the microimage array is different from those in the first region, such that a second synthetic image is generated, different from the first synthetic image. For example, the graphical content of the microimages formed in the first region could be different from that in the second region, so that different images are visible in each region (e.g. images of the digit “10” in the first region and “£” (pound) signs in the second region). Alternatively, the pitch or relative orientation of the lens and microimage arrays could be different in the two regions so that (in the case of a moiré magnifier type device), the degree of magnification and/or the plane in which the image is formed is different for the two regions. In a particularly advantageous example, the array of lenses and the microimage array are configured such that the first synthetic image is generated on an image plane which appears to the observer to be located behind the array of lenses, and the second synthetic image is generated on an image plane which appears to the observer to be located in front of the array of lenses.

Alternatively, the tactile element(s) could be positioned to draw the user's eye to the lens-based feature (or vice versa) in some other way. Thus, the array of lenses and microimage array are preferably configured such that in a first region of the device, a first synthetic image is generated and the at least one tactile element includes one or more markers configured to mark the location of the first region. For example, the tactile element(s) could take the form of one or more arrows pointing to the lens-based feature, or the tactile element(s) could make up one portion of a recognisable object (e.g. a letter or number), with the lens-based feature forming another portion of the same object. Any discrepancy in the relative positioning of the tactile element(s) and the lens-based feature will then be readily apparent.

In one such example, the first region is elongate and the at least one tactile element includes a marker aligned with and adjacent to each of the two ends of the elongate first region. The two markers clearly identify the intervening line along which the user should expect to find the lens-based feature. Preferably, the first region comprises a plurality of sub-regions arranged along a line, and the at least one tactile element includes a plurality of markers aligned with and interspersed between the sub-regions along the line. Multiple such lines may be provided parallel to one another. Thus when a user runs their finger over the lines (perpendicularly to the long axis), a recurring tactile sensation will be felt. When inspected visually, the user will expect to find the visual effects generated by the lens-based device in line with the tactile lines. The lines could be rectilinear, curved, sinusoidal or zig-zag lines for example.

In other cases it is preferred that the at least one tactile element is provided in the form of a letter, number, alphanumerical text, Braille markings, a symbol, logo or graphic.

As already mentioned, the microimage array is located in or around the focal plane of the lenses such that a synthetic image is generated. Most preferably, the microimage array is disposed substantially in the focal plane of the lenses such that the synthetic image of the microimage array is a substantially focussed image. For example, the microimage array may preferably be positioned within +/− 100 microns of the focal plane. In practice, due to variations in the printing of the lenses the microimage array may be up to 300 microns away from the focal plane and it has been found that a synthetic image will still be generated, albeit not as clear an image.

Advantageously, the at least one tactile element is substantially transparent: that is, it can be seen through. Hence, where the at least one tactile element is formed by application of a material, it is preferable that the material is substantially transparent. This reduces the visual impact of the tactile element(s) and is of particular use where the device is to overlie data in a security document, e.g. the holder's photograph, since the tactile element will then not significantly interfere with viewing the data.

In particularly preferred embodiments, the tactile element(s) and lens-based device are arranged such that, together, they form a complete image. If either part were omitted from a counterfeit device, it would be clear that a part of the image were missing. This arrangement would be particularly advantageous where a low visual impact (e.g. transparent) tactile feature is arranged to overlay personalisation data such as the holder's photograph.

Preferably the printed lenses and the material forming the at least one tactile element comprise the same material. This enables the lenses and the tactile element(s) to be laid down in the same working if desired or at least formed using the same methods. Suitable materials for forming lenses and tactile elements include transparent, UV curable inks such as those based on epoxyacrylates, polyether acrylates, polyester acrylates and urethane acrylates.

The lenses and/or tactile elements may preferably be colourless (clear) such that the presence of the device does not alter the appearance of any underlying data or graphic. However, in preferred cases, the printed lenses and/or the material forming the at least one tactile element may comprise a coloured tint. The coloured tint can be provided using a dye or a pigment. In one example, the coloured tint was provided by adding 5% by weight of a coloured UV curable ink such as Omniplus UL from Sericol. Most advantageously, only the tactile element(s) will be coloured whilst the lenses are preferably clear such that any visual effect on underlying data or graphics is kept to a minimum.

In a particularly preferred embodiment, the printed lenses and the material forming the at least one tactile element comprise the same material, having a coloured tint concentration selected such that the lenses formed of the material appear substantially clear, whilst the at least one tactile element exhibits a colour. In this way, the lenses and the tactile element(s) can be laid down in the same working if desired or at least formed using the same methods, whilst still limiting the visual impact to the tactile areas. For instance, adding 5% by weight of Omniplus UL from Sericol to any of the transparent materials mentioned above was found to give an appropriate colour level to positive tactile elements whilst leaving the lenses substantially colourless.

In other embodiments it is advantageous to provide a sufficiently high colour concentration that the lenses themselves take on a coloured tint. In this case, the tinted lenses will alter the apparent colour of the synthetic images due to subtractive colour mixing. In preferred implementations, the colour of the lens tint is selected as the complementary colour to that of the microimages. This selection enhances the contrast in the resulting synthetic images. For example, if the microimages are blue, the lenses may be tinted yellow. The yellow tint in the lenses will subtract the blue light from the microimages making them appear darker relative to their background. Of course, any other complementary colour combination could be used instead.

The microimages could be disposed on either side of the substrate, e.g. under the lenses on the first surface. However, in preferred examples, the microimage array is provided on the second side of the substrate, and the substrate is substantially transparent. This increased distance between the lenses and microimages (and correspondingly increased focal length of the lenses) leads to an improved visual effect. The substrate could be a multilayered substrate.

It should be noted that the microimages need not be formed on the substrate. For instance, the microimages could be formed on the surface of another layer which is then applied to the substrate such that the microimages sit adjacent the substrate surface. The microimages could also be formed over a layer of adhesive carried by the substrate or by such an adjacent layer.

The lenses (and the tactile elements, if printed) could be formed using any suitable printing technique but in preferred cases, the printed lenses and/or the at least one tactile element are formed by screen, flexographic or inkjet printing. For tactility, higher structures and ink weights are preferred which makes screen printing particularly advantageous.

The microimages could be formed using any technique resulting in visible markings. In preferred examples, the microimages are formed by printing, preferably offset, gravure or flexographic printing, patterned metallisation, or laser marking. A particular benefit of laser marking is that it is possible to combine personalisation (e.g. serial number or personal data) with an optically variable effect. If the laser marking is done through the lenses then the resulting effect will alter with angle when viewed through those same lenses. The laser markable material could be a layer of ink (e.g. offset printed) or other coating applied in the desired plane, which is altered by interaction with the focussed laser. Multiple images can be written into the markable material by altering the angle at which the laser beam hits the device. Alternatively, one or more of the arrays of microimage elements could also be formed as grating structures, recesses or other relief patterns on the substrate. Anti-reflection structures may also be used as described in WO-A-2005/106601. The microimages could be formed on a surface of the substrate or on a separate layer which is overlapped with the substrate on which the lens array and tactile element(s) are formed.

The visual effect resulting from the synthetic image can operate on any mechanism, but preferably achieves an optically variable effect (i.e. the appearance is different at different viewing angles). In one preferred implementation, the array of lenses and microimage array form in combination a lenticular device, the microimage array preferably comprising a first set of microimages making up a first composite image and a second set of microimages arranged such that when the lenticular device is viewed from a first angle, a synthetic version of the first composite image is generated, and when the lenticular device is viewed from a second angle, a synthetic version of the second composite image is generated. Any number of such composite images may be provided, optionally configured to give rise to an animation effect when the device is tilted.

In another preferred embodiment, the array of lenses is a regular array of lenses, and the pitches of the lenses and the array of microimages and their relative locations are such that the array of lenses cooperates with the array of microimages to generate a magnified version of the microimage elements due to the moiré effect, the array of lenses and microimages forming in combination a moiré magnification device.

In accordance with the first aspect of the invention, a plurality of security devices each as described above may be provided, wherein the synthetic image and the at least one tactile element have substantially the same positions relative to one another in each of the plurality of security devices at least when the devices are viewed from the normal. That is, as a result of the registration described above, the relative locations of the lens array and/or microimage array and the at least one tactile element is reproduced in each of the security devices in the set (to within a tolerance of ±2 mm, more preferably ±1 mm, still preferably ±0.5 mm and most preferably ±0.1 mm). In this way, as already described, the difficulty of producing a counterfeit device is increased since a person checking the devices will readily spot examples in which the optical effect produced by the lens array is not correctly positioned relative to the tactile feature(s).

The first aspect of the invention further provides a method of manufacturing a security device, comprising, in any order:
providing an array of microimages on a substrate;
printing an array of lenses onto a first surface of the substrate such that when the array of microimages is viewed through the array of lenses, a synthetic image of portions of the microimages is generated; and
forming in registration with the array of lenses and/or the array of microimages at least one tactile element on the first surface of the substrate which is of greater or lesser height than the printed lenses.

As described above, by forming tactile elements in registration with the lens array on the same surface, the difficulty of accurately forging a counterfeit device is significantly enhanced.

As noted already, the tactile element(s) can be positive or negative. Thus, in one preferred example, the at least one tactile element is formed by omitting lenses across an area of the substrate during printing of the array of lenses, which area is defined on at least two sides by the array of printed lenses. This results in a negative tactile element.

In other preferred cases, the at least one tactile element is formed by depositing material on an area of the substrate, the height of the material defining the height of the tactile element. This can be used to form positive or negative elements. Advantageously, the at least one tactile element is formed by printing, the material preferably being deposited by means of the same printing technique as that by which the array of lenses is printed. This allows for particularly high registration.

For 100% registration, the array of printed lenses and the at least one printed tactile element are formed in the same printed working. However, in other cases, it is preferred that the array of printed lenses is formed by means of a printed lens working and the at least one printed tactile element is formed by means of a printed tactile working, the two workings being laid down in either order. This still achieves high registration yet improves the flexibility of the method since, for example, different materials (e.g. different tint concentrations) can be used to form the lenses and the tactile elements, respectively. Preferably, the printed lens working is laid down before the printed tactile working.

In some preferred embodiments, the printed lens working comprises at least one area in which no lenses are present, and the printed tactile working comprises at least one tactile element located in the at least one area. In other cases it is preferred that the printed tactile working includes at least one tactile element located over one or more of the printed lenses.

As noted above, the array of microimages can be provided in various ways, including forming the microimages on either surface of the substrate, or on the surface of another layer which is then applied to a surface of the substrate.

The method can be adapted to provide the security device with any of the features described above.

A second aspect of the invention provides a security device comprising an array of printed lenses arranged on a first surface of a substrate and a microimage array underlying the array of printed lenses and disposed in the focal plane of the lenses, whereby a synthetic image of portions of the microimages is generated by the lenses, the security device further comprising at least one latent element arranged on the first surface of the substrate which scatters incident light in fewer directions than the printed lenses, such that the visibility of the at least one latent element varies as the device is tilted, the at least one latent element being registered to the array of printed lenses and/or the microimage array.

In common with the first aspect of the invention, by combining a lens-based visual effect with another security feature on the same surface and registering the two to each other, the difficulty of counterfeiting the device is enhanced. Like tactile elements, latent features can be arranged to impose little visual impact on the device and as such do not detract significantly from the visual effect of the lens-based feature, yet are visible when the device is tilted. For instance, the latent element may be substantially invisible when the device is viewed from certain positions. At these viewing angles, the latent element may not be distinguishable from the region(s) containing the lenses. As the device is tilted, the latent element reflects light in specific directions defined by its contours whilst the lens array region appears relatively matte since the lenses tend to scatter incident light in more directions. For instance, hemispherical lenses scatter light in all directions whereas elongate printed lines scatter in one axis only. As a result, it possible to provide up to three levels of contrast between the reflectivity of (i) hemispherical lenses, (ii) printed lines and (iii) flat or unprinted regions. The greatest contrast will be seen between hemispherical lenses and (non-scattering) flat or unprinted regions, but forming the latent region(s) of printed elongate lines allows greater design flexibility since the orientation of the lines can by varied by region which cause those regions to appear to turn on and off as the lighting angle is varied.

Thus, as the device is tilted, different parts of the latent element(s) may appear bright as they reflect light towards the observer. For instance, typically there will be at least one viewing angle at which the latent element appears brighter than the lens array region(s) and more generally there may be a narrow range of viewing angles at which this is the case. This is due to the reflection characteristics of the latent element being specular as compared with the lenses, which will reflect more diffusely. In preferred examples, the at least one viewing angle (or the narrow range of viewing angles) will be away from the normal viewing position (i.e. not perpendicular to the device), such that when the device is viewed along the normal, the latent element(s) is substantially invisible.

In order to achieve the desired reflection characteristics, the latent element(s) are preferably smooth relative to the lens array. That is, any variation in the height of the latent element(s) preferably has a lower spatial frequency (i.e. occurs over a greater distance) than that of the lens array.

Again, it is preferred that the at least one latent element comprises an area of the substrate in which no operative printed lenses are present. As described above, this means that no lenses which are capable of diffracting light in the required manner to generate a synthetic image are present and hence there is no generation of such an image in the locality of the at least one tactile element. For instance, no elements which focus light from the plane in which the microimage array sits are present.

The latent element(s) can be formed in various different ways akin to the formation of tactile elements as described in relation to the first aspect of the invention. Indeed, the latent element(s) may additionally be tactile relative to the lenses, but this is not essential. Hence, in one embodiment, the at least one latent element comprises an area of the substrate in which the printed lenses are absent, which area is defined on at least two sides by the array of printed lenses, the first surface of the substrate being glossy relative to the array of printed lenses.

In another preferred embodiment, the at least one latent element comprises an area of the substrate on which is disposed material which is glossy relative to the array of printed lenses. Advantageously the at least one latent element is a printed latent element, preferably deposited by means of the same printing technique as that by which the array of lenses is printed. This enables the lenses and latent elements to be laid down simultaneously or in sequential steps in an in-line process, hence ensuring high registration. For 100% registration, the array of printed lenses and the at least one printed latent element preferably form part of the same printed working. In other cases it is advantageous that the array of printed lenses forms part of a printed lens working and the at least one printed latent element forms part of a printed latent working, for instance if two different materials are to be used to form each working.

As in the case of tactile features, preferably the printed lens working underlies the printed latent working, and the latent element(s) may coincide with areas of the printed lens working in which the lenses are absent, or could overlie the lenses.

Advantageously, the at least one latent element is substantially transparent: that is, it can be seen through. Hence, where the at least one latent element is formed by application of a material, it is preferable that the material is substantially transparent, preferably substantially colourless. As in the case of the first aspect of the invention, this ensures that viewing of any underlying information is not obstructed.

As in the first aspect of the invention, preferably the microimage array is disposed substantially in the focal plane of the lenses such that the synthetic image of the microimage array is a substantially focussed image.

The latent element(s) are preferably arranged to convey a direct relationship with the lens-based device, as previously described in relation to tactile elements. Hence, in one preferred example, the array of lenses and microimage array are configured such that in a first region of the device, a first synthetic image is generated and in a second region of the device, laterally offset from the first region, a different visual appearance is exhibited, the at least one latent element including a latent element disposed at a boundary between the first and second regions. All of the considerations applied to the layout of tactile elements in this connection above apply equally to latent elements.

Preferably, the at least one latent element is provided in the form of a letter, number, alphanumerical text, Braille markings, a symbol, logo or graphic.

As in the first aspect of the invention, the lens-based device is preferably a lenticular device or moiré magnifier.

In accordance with the second aspect of the invention, a plurality of security devices each as described above may be provided, wherein the synthetic image and the at least one latent element have substantially the same positions relative to one another in each of the plurality of security devices, at least when the devices are viewed from the normal.

The second aspect of the invention further provides a method of manufacturing a security device, comprising, in any order:
providing an array of microimages on a substrate;
printing an array of lenses onto a first surface of the substrate such that when the array of microimages is viewed through the array of lenses, a synthetic image of portions of the microimages is generated; and
forming in registration with the array of lenses and/or with the microimage array at least one latent element on the first surface of the substrate which scatters incident light in fewer directions than the printed lenses, such that the visibility of the at least one latent element varies as the device is tilted.

This results in a security device which is particularly difficult to counterfeit, as previously described. Any of the method steps described above in relation to the formation of a device with tactile elements can be adapted for the formation of a device with latent elements. Again, the microimages need not be formed on the substrate. For instance, the microimages could be formed on the surface of another layer which is then applied to the substrate such that the microimages sit adjacent the substrate surface. The microimages could also be formed over a layer of adhesive carried by the substrate or by such an adjacent layer.

Security devices comprising lens and microimage arrays such as those discussed above and others can advantageously be applied over a layer displaying information, such as a graphics layer to form in combination a security device assembly. The displayed information and graphics can be observed through the device with the synthetic images appearing superimposed. However, it has been found that the synthetic images observed in such scenarios may appear indistinct. This carries some benefits in that the underlying graphics are not significantly obscured, but also diminishes the secure visual effect. It would be desirable to improve the security level of the overall device.

A third aspect of the invention therefore provides a security device assembly comprising:
a security device comprising an array of lenses arranged on a first surface of a substrate and a microimage array underlying the array of lenses, whereby a synthetic image of portions of the microimages is generated by the lenses;
a graphics layer underlying the security device, the microimage array being disposed between the array of lenses and the graphics layer such that the graphics of the graphics layer and the synthetic image generated by the array of lenses are viewable from the same side of the security device assembly; and
a region of substantially uniform appearance underlying the microimage array across a portion and not the whole of the security device, the region being formed by a masking layer applied between the microimage array and the graphics layer, or by an area of the graphics layer carrying no graphics.

By providing the security device assembly with a uniform region in this way, the synthetic image formed by the lens array is locally enhanced. That is, the images are more clearly apparent to the observer, appearing for example to possess greater contrast with their surroundings. This is due at least in part to the uniform region providing a plain background without visual features such as patterns which would otherwise confuse the eye. Thus, in at least the portion of the device assembly corresponding to the region, the synthetic image is clearly apparent, producing a strong visual impact which is easy to check for and difficult to imitate, thereby increasing the security level of the device. In the remaining areas of the device assembly, the graphics layer is visible in a conventional manner through the security device with the corresponding synthetic images appearing relatively indistinct such that the underlying graphics are not concealed.

In the third aspect of the invention, the security device could be a security device in accordance with the first or second aspects of the invention, but this is not essential.

The region of substantially uniform appearance could take any form which results in a plain, unvarying appearance to the observer, e.g. a solid area of a single colour. However in particularly preferred embodiments, the region comprises a reflective material, preferably a specularly reflective material, in the form of a masking layer or forming part of the graphics layer. This has been found to be particularly effective, resulting in a bright background against which the synthetic images show sharp contrast.

Where the region of substantially uniform appearance comprises a masking layer this can be formed in various ways but is preferably printed, deposited or otherwise coated onto the microimage array and/or onto the graphics layer.

In particularly preferred examples, whether the region is provided as a masking layer or forms part of the graphics layer, the region of substantially uniform appearance comprises ink, preferably metallic ink, or a foil, preferably a metallic foil. Advantageously, the ink or foil is substantially visually opaque such that any underlying graphics or visual variation are not visible therethrough.

Preferably, the region of substantially uniform appearance is bounded by graphics of the graphics layer and, optionally, edges of the security device assembly. Thus, the region sits adjacent graphics of the graphics layer forming a localised, clearly delimited area readily identified by a user. The region could abut one or more edges of the device, e.g. appearing as a strip along a side of the device, or could be surrounded on all sides by the graphics of the graphics layer (i.e. the region of substantially uniform appearance is bounded on all sides by graphics of the graphics layer).

Preferably, the graphics of the graphics layer may include any of: security prints, guilloches, microtext, and repeating geometric patterns.

The invention further provides a security article comprising a security device according to the first or second aspects of the invention, or a security device assembly according to the third aspect of the invention, wherein the security article is preferably a label, cover film, patch, foil, security strip or security thread. The security article can be incorporated into or affixed to any object of value whose authenticity is desired to be testable.

Security devices as described above find particular utility in the field of security documents and hence the present invention further provides a security document comprising a security device according to the first or second aspects of the invention, or a security device assembly according to the third aspect of the invention, or a security article as described above, wherein the security document is preferably a bank note, passport, ID card, drivers' licence, visa, or certificate. The device could be incorporated for instance as a label or cover film adhered to the security document. However, in preferred cases, the device or device assembly is an integral part of the security document. For instance, in a particularly advantageous embodiment, the security document is of a multilayered construction, the substrate forming an integral layer of the document, the first surface of the substrate carrying the array of lenses being an outermost surface of the security document. For example, the security document may be an ID card or drivers licence card having a graphics layer on which the holder's data is printed, laminated with an overlying substrate of the sort described above, with the lens array and tactile and/or latent element(s) on its outer surface.

In another case, any of the described security devices could be incorporated into a polymer banknote. For example, WO-A-83/00659 describes a polymer banknote formed from a transparent substrate comprising an opacifying coating on both sides of the substrate. The opacifying coating is omitted in localised regions on both sides of the substrate to form a transparent region in which any of the presently disclosed security devices may be located. Alternatively the opacifying coating could be omitted only on one side of the substrate to form a half-window as described in EP935535B1. In this case the lenses would be on the opposite side of a transparent substrate to the opacifying coating. The microimages could be printed under the opacifying coating on the opposite side from the lenses, or could be formed from the opacifying coating itself. In some scenarios the opacifying coating could provide the masking layer described above.

Examples of security devices, security articles and methods for their manufacture will now be described with reference to the accompanying drawings, in which:—

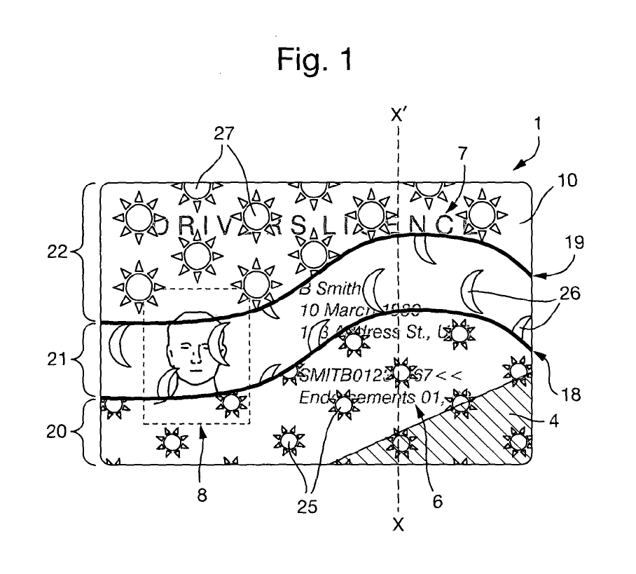

FIG. 1 schematically depicts a security document in accordance with a first embodiment of the invention, in plan view;

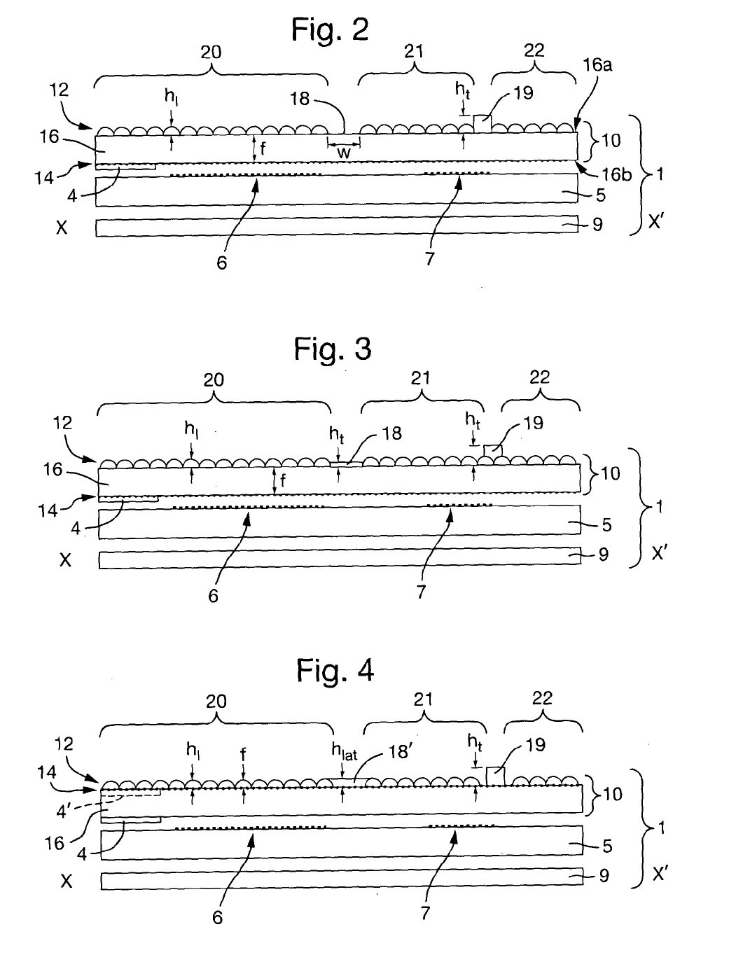

FIG. 2 is a cross section through the security document of FIG. 1 along the line X-X′;

FIG. 3 is a cross section through a security document in accordance with a second embodiment, the security document having substantially the same appearance in plan view as shown in FIG. 1;

FIG. 4 is a cross-section through a security document in accordance with a third embodiment, the security document having substantially the same appearance in plan view as shown in FIG. 1;

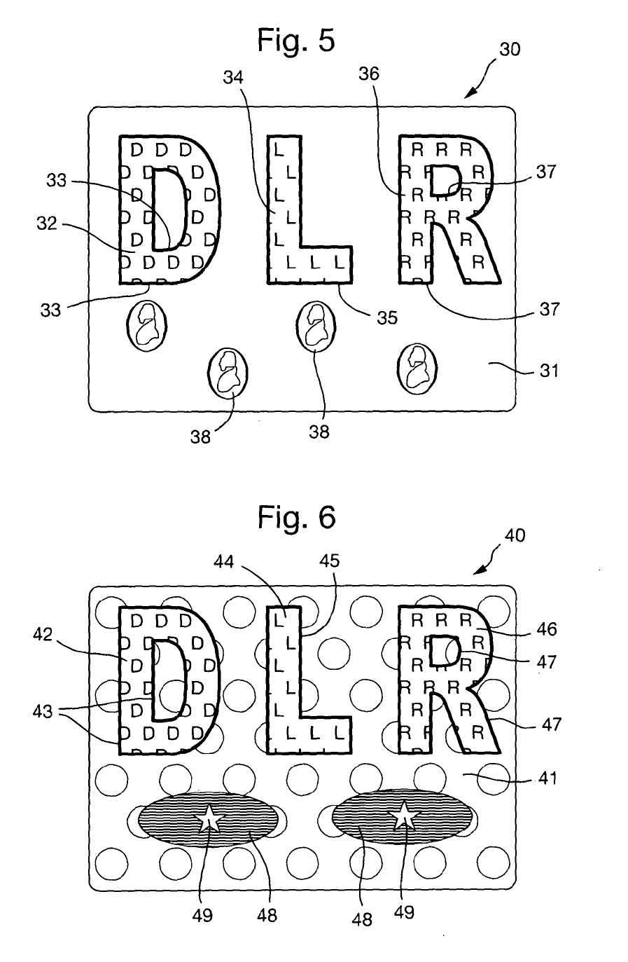

FIGS. 5 to 12 show further embodiments of security devices in plan view;

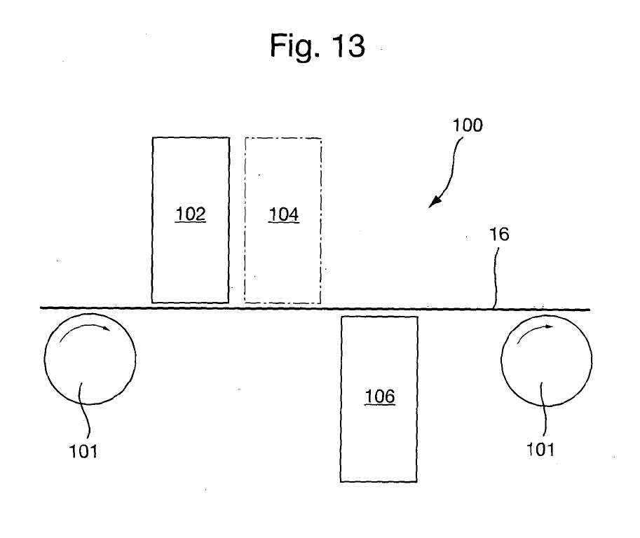

FIG. 13 illustrates an embodiment of apparatus suitable for manufacturing a security device;

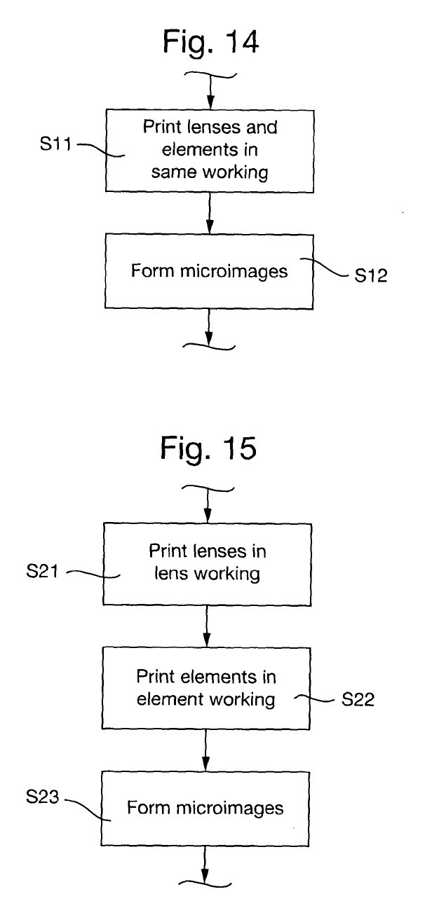

FIG. 14 is a flow chart showing steps in a first embodiment of a method of manufacturing a security element;

FIG. 15 is a flow chart showing steps in a second embodiment of a method of manufacturing a security element;

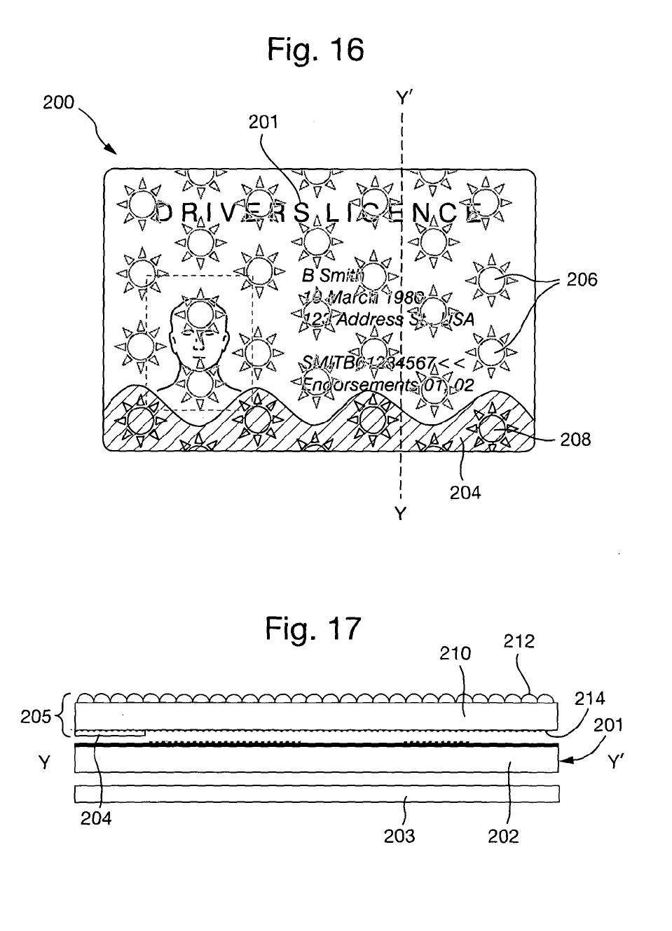

FIG. 16 schematically depicts a security document in accordance with a further embodiment of the invention, in plan view;

FIG. 17 is a cross section through the security document of FIG. 16 along the line Y-Y′; and

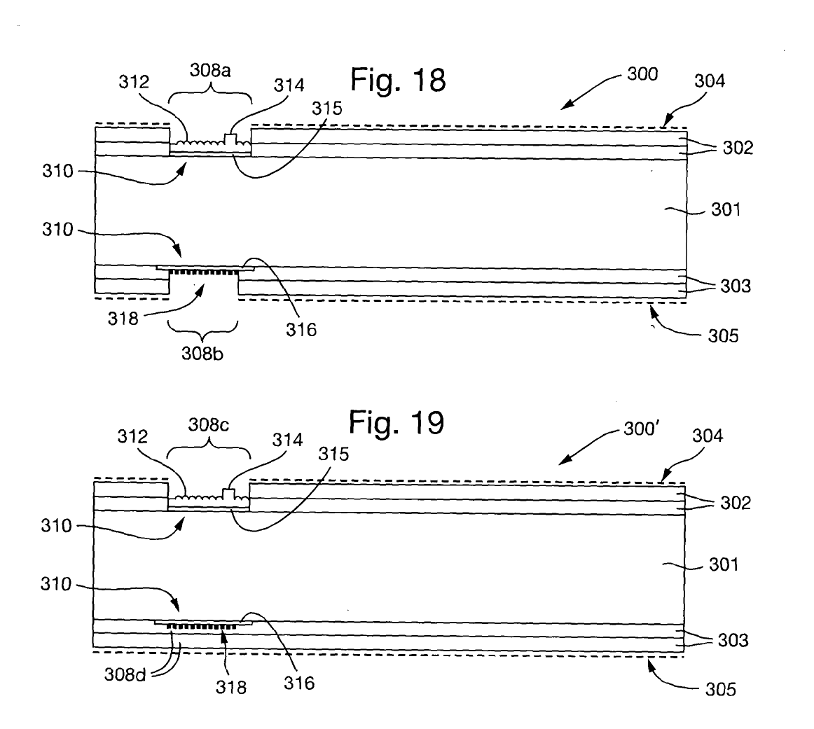

FIGS. 18 and 19 are cross sections through security documents in accordance with two further embodiments.

Security devices of the sort presently disclosed can be applied to any object of value where it is desirable for the authenticity of the object to be checkable, e.g. clothing, CDs, computer hardware etc. However, the security devices find particular utility in the field of security documents and the description below will therefore focus on this example. The security devices can be applied to or incorporated into security documents such as currency, ID cards, drivers' licences, passports etc., in various ways as will be described further below.

In a first embodiment, shown in plan view in FIG. 1, a security device 10 forms an integral part of a security document 1, which here is a drivers' licence in the form of a card. Typically the card is approximately the same size as a credit card, e.g. suitable for carrying in a person's wallet. As shown in the cross section of FIG. 2, the card 1 is of a multilayered, laminate construction, comprising a layer 5, formed for example of paper, card or a suitable polymer such as Teslin™, on which graphics and/or data are provided, which is covered by the security device 10. Optionally a protective layer 9 may also be provided to cover the opposite surface of layer 5. The protective layer 9 could comprise for instance a transparent polymer film or could be a second security device of the same type of construction as device 10. In FIG. 2, the various layers making up card 1 are shown spaced from one another for clarity. However, in practice the layers will be secured together, e.g. by adhesive or heat sealing.

In other cases, a similar end structure can be attained by forming the device 10 as a label or cover film, e.g. with a self-adhesive backing, and adhering it to a document, e.g. onto a page of a passport or onto the surface of a banknote. Alternatively, the device can be integrally formed in a document such as a polymer banknote, and examples of such implementations will be provided below.

The graphics and/or data carried by layer 5 may take various forms. In the case of an ID card or driver's licence (as shown), typically there will be a combination of personalisation data such as the holder's name, address and other identifying information (item 6 in the Figures), as well as invariable graphics such as the wording “DRIVERS LICENCE” (item 7 in the Figures), which will not change from one document to the next. There may also be a photograph 8 of the holder and typically additional design features such as background printing or security elements such as fluorescent substances, thermochromic substances, magnetic materials, optically variable inks (e.g. pearlescent or iridescent inks). Any appropriate techniques could be used to apply the graphics or data to layer 5, including secure printing techniques such as screen, lithographic or offset printing as well as more widely available techniques such as ink jet printing. The graphics and/or data could also be laser-marked.

In this example, the security device 10 is at least semi-transparent (at least across a major proportion of its surface area) and so the data and/or graphics provided on layer 5 remains visible once covered by the device 10. FIG. 1 shows the appearance of the card 1 with the device 10 in place, and it will be seen that the data items 6, 7, 8 remain visible: in the Figures, these items are depicted in grey for clarity, but in practice they will be readily apparent through device 10, and indeed dominate the appearance of the card 1.

The device 10 comprises a (optionally multilayered) substrate 16 which here is transparent (preferably colourless), made for example of one or more plastics materials such as polyethylene terephalate (PET), polycarbonate (PC), polyvinylchloride (PVC), polybutlylene terephalate (PBT), nylon or acrylic. On a first surface 16a of the layer 16, an array of printed lenses 12 is provided. In this example, the lenses are hemispherical lenses arranged on a close-packed regular two dimensional grid. However, in other examples the lenses may be polygonal (e.g. having a square or hexagonal shape when viewed from above) or could be elongate (e.g. cylindrical lenses). The lenses 12 are formed by printing a suitable transparent material onto the substrate 16, as described for example in U.S. Pat. No. 7,609,451 or US-A-2011/0116152. Suitable lens materials include UV curable polymer resins such as those based on epoxyacrylates, polyether acrylates, polyester acrylates and urethane acrylates. Examples include Nasdar™ 3527 supplied by Nasdar Company and Rad-Cure™ VM4SP supplied by Rad-Cure Corporation. When deposited onto the surface 16a, the material adopts a dome-like or curved profile, at least across a portion of its area, causing the material to focus light transmitted therethrough. Generally, the larger the lateral extent of the lens, the flatter the lens profile will be and hence the longer its focal length.

In or around the focal plane of the lenses 12, an array of microimages 14 is provided. In this example, the focal length of the lenses, f, is configured to equate approximately to the thickness of the substrate 10 (e.g. the focal length f is within about 300 microns of the substrate thickness), which is at least semi-transparent and preferably colourless. The array of microimages 14 is therefore provided at the second surface 16b of the substrate 16, e.g. by printing or marking the microimages onto the second surface 16b, or by forming the microimages on another support layer (not shown), which is disposed adjacent the second surface 16b. In another example, a layer of adhesive could be applied to the second surface 16b of the substrate and the microimages formed on the layer of adhesive. The adhesive can then be utilised to join the device 10 to an underlying layer such as layer 5 in FIG. 2. In a still further example, the array of microimages 14 could be formed on the surface of the underlying layer 5, e.g. over the graphics 6, 7, 8. When assembled, the layer 5 sits adjacent the substrate 16 such that the microimages 14 would be located at the second surface of the substrate 16. In this case, the lamination of the substrate 16 onto layer 5 is preferably registered to ensure the lens region and microimage array coincide, although if both the lens array and the microimage array cover the whole area then this is not necessary. In yet another example, the microimage array could be formed on a layer of adhesive applied to the surface of layer 5 which is used to join it to the substrate 16. Alternative the array could be located between two layers of adhesive provided between substrate 16 and layer 5, which introduces an additional tamper evident feature since, should delamination be attempted, the microimages will be destroyed.

The lenses 12 and microimages 14 in combination produce an optically variable effect, the appearance of which varies at different angles of view. The nature of the microimages will depend on the desired effect. For example, the lenses and microimages may be configured to form a lenticular device wherein, at any one angle of view, each lens generates a synthetic image (preferably a focussed synthetic image) of one underlying microimage which together form a composite image. When viewed from another angle, a different set of microimages is directed to the viewer by the lenses to form another composite image. If the two sets of microimages are different, the observer will therefore perceive a switch in the displayed image as the device is tilted. If three of more sets of microimages are provided, an animated effect can be achieved. Typically, for a lenticular device, the lenses 12 will be elongate (e.g. cylindrical) such that the switching or animation effect is only visible when the device is tilted about one axis (e.g. parallel to the long axis of the cylindrical lenses).

Alternatively, the lenses and microimages may in combination form a moiré magnification device, and this is the case in the example illustrated in FIG. 1. Here, the microimage array comprises a regular grid of images which are typically identical to one another although this is not essential. The microimage array 14 and lens array 12 are mis-matched to one another, either in terms of their pitches being non-identical, or in terms of an angular displacement between the two arrays, or both. When the microimage array is viewed through the lens array, each lens magnifies a different portion of an underlying microimage. The result is a “magnified” image of the microimages which in fact is a composite image made up of the individual magnified portions.

In the example shown in FIG. 1, the card 1 is divided into three laterally offset regions, 20, 21 and 22. In region 20, the lenses and microimages are configured to give rise to magnified “sun”-shaped images 25. The images 25 will appear to sit on an image plane which may be above or below the plane of the device (depending on the degree of mismatch), giving the perception of depth or of “floating” images accordingly. In region 21, different microimages are provided having the appearance of crescent “moons”, resulting in magnified “moon” images 26. In region 22, the microimages 14 are identical to those of region 20, but the mismatch between the lens array 12 and the microimage array is different to that in region 20, resulting here in a higher magnification level and thus larger “sun”-shaped images 27. As the device is tiled, the magnified images 25, 26, 27 appear to move relative to the edges of the device as different portions of the microimage array are magnified by the lenses.

It should be noted that the microimages are here semi-transparent such that the magnified images will not significantly obstruct the viewing of the underlying data/graphics carried on layer 5 of the card 10.

Optionally, a region 4 may be provided which provides a background of substantially uniform appearance for the synthetic images generated by the array of lenses in a localised portion of the device. As shown in FIG. 1, here the region 4 covers a corner portion of the device bounded by two edges of the card 1. In this region 4, the graphics and other patterns and information exhibited by layer 5 (e.g. data items 6, 7 and 8) are not visible, with the synthetic images generated by the lenses being viewed instead against a uniform background. This has been found to significantly enhance the appearance of the generated images, due in part to a reduced level of distraction for the eye in the uniform region 4. The uniform region 4 could be formed by printing or coating, for example, and has been found to be particularly effective when formed of a reflective, preferably metallic material.

The provision of a uniform region 4 can be achieved in various ways as exemplified in FIGS. 2, 3, and 4 which show region 4 formed as a masking layer applied underneath the microimage array. This and other implementation options will be discussed in more detail in connection with FIGS. 16 and 17 below.

Since the lenses 12 are printed, the configuration of the lenses can be varied in each region of the device by appropriate control of the printer in order to attain different visual effects in each region of the device. This could be used to obtain different magnification levels as mentioned above or to provide different types of visual effect mechanism (e.g. lenticular and moiré magnifier) on the same device.

In addition to the lens array 12, the first surface 16a of the substrate 16 is also provided with at least one tactile or latent element (or at least one element having both properties), which is registered to the lenses and/or to the microimages. That is, the at least one tactile or latent element has a location which is reproduced to a high level of accuracy in each device of the same design (e.g. each device in a series or batch of matching devices) with respect to the synthetic image generated by the lenses and microimages in combination. By providing the device with tactile and/or latent elements in registration with the lens-based effect, it is significantly more difficult for a counterfeiter to produce a passable imitation of the device, because they will not be able to achieve the necessary registration. As such, in a counterfeit device, the relative locations of the lenses/microimages and any tactile or latent regions will inevitably vary from one device to another and it is extremely difficult for the counterfeiter to achieve the correct positioning.

An additional advantage of providing a moiré magnifier type device with a tactile element is that a counterfeiter may attempt to imitate a moiré magnification effect using a lenticular device, because suitable lens arrays are more readily available. Providing a tactile element encourages the user to feel the device and if a lenticular device is present where not expected, this is likely to be detected since lenticular devices are generally fairly coarse relative to moiré magnifiers and so the ridges will be felt.

To make such a failure to register the elements even more apparent (e.g. when a counterfeit device is compared with an authentic device), it is desirable to position the tactile and/or latent element(s) at a location relative to the visual effects generated by the lens and microimage combination that is readily identifiable, i.e. one which has a direct and unambiguous relationship to the visual effect. In the present example, this is achieved by locating tactile elements 18, 19, along the boundaries between regions 20 and 21, and regions 21 and 22, respectively. In FIG. 1, the tactile lines 18, 19 are shown in black for clarity. However, usually the tactile elements are at least semi-transparent, preferably substantially transparent (i.e. see-through) and most preferably colourless, so as not to impose a significant visual impact on the device.

In order to be detectable by touch, the tactile elements 18, 19 have a height hₜ which is different from that of the lenses, hₗ. As shown in FIG. 2, the respective heights are defined relative to the first surface 16a of the substrate. Whilst the curved profile of the lenses means that different parts of each lens will stand proud from the surface 16a by different amounts, it is the maximum height of each lens that is of relevance since it is this which will be detected by the user. Typically, the lenses in the array will all be of substantially the same (maximum) height, but should this not be the case, it is the average height that is of importance. Preferably, there is a height difference of at least 5 microns, more preferably at least 10 microns, between the tactile elements and the lenses. Such height differences have been found to be readily detectable by touch on a smooth substrate.

The tactile elements can be formed in various ways and may be “positive” or “negative”. In both cases it is preferred that no operative lenses remain in the area forming the tactile element(s) such that no synthetic image is generated in that area. In the present example, element 18 is a negative element, having a height lower than that of the lenses, and element 19 is a positive element, having a greater height than that of the lenses. A negative element such as line 18 can be formed by omitting lenses in the area corresponding to the desired element shape from the lens array during its printing, as depicted in FIG. 2. In this case, the “height” of the element is zero such that the difference in height between the tactile element and the lenses is equal to the height of the lenses.

Element 19 is a positive tactile element, formed by the deposition of a suitable material onto the device to a height greater than that of the lenses. Suitable materials include conventional transparent inks and polymer resins, and UV curable screed printable resins are particularly suitable including those based on acrylate systems. Specific examples of screen printable inks include UVRS912 and UVLB 1 inks supplied by Marabu GmbH and Co. In particularly preferred cases, the material used to form the tactile element(s) may be the same as that from which the lenses 12 are formed. The material is preferably laid down by printing, which assists in achieving high registration between the lenses and the tactile elements since both can be formed in the same print run, e.g. in sequential steps of an in-line process, or even in the same printing step. In the example shown, the lenses 12 and tactile element 19 form part of one and the same printed working, formed for example by screen printing with a screen defining both the lenses and the line 19. This leads to 100% registration between the tactile element and the lenses.

Typical lens heights are of the order of 9 to 10 microns and the present inventors have found it possible to lay down tactile elements with a height of up to 22 microns in the same printed working.

The lateral width w of the tactile/latent elements can be selected as appropriate for the design of the device. However, particularly in the case of negative tactile elements, their width w (e.g. linewidth) should be sufficient to allow their detection. If a negative tactile element is too narrow, the user may pass their finger or fingernail over the lens surface, “bridging” the gap where the tactile element is located and hence not detecting its presence. Hence, negative tactile elements preferably have a width of at least 100 microns. More generally, the tactile or latent elements preferably have a width of between 100 microns and 5 millimetres, more preferably between 250 microns and 3 millimetres, still preferably between 500 microns and 2 millimetres.

In a second embodiment, shown in FIG. 3, the lenses and tactile elements are formed in two separate printed workings. In this example, the printed lens working is laid down first, and includes a gap in the area corresponding to line 18. The lens array is continuous across the area in which line 19 is to be formed. In a second printed tactile working, material is laid down to form the two tactile elements. Element 18 is formed with a height hₜ which is less than that of the lenses, hₗ, resulting in a negative tactile element as before. Element 19 is formed by laying down material on top of the lenses 12, resulting in a positive tactile element. The material from which element 19 is formed preferably has substantially the same refractive index as that of the lenses 12, such that the underlying lenses 12 in the area of element 19 cease to be operative, their functional surface shape being “indexed-out” by the coating. Tactile elements formed in a separate working from the lenses can be provided with a wide range of heights and particularly prominent features may be formed by placing the material on top of lenses 12 as shown in FIG. 3.

A further alternative embodiment is shown in FIG. 4. Here, only element 19 is tactile whilst element 18′ is a latent element. A latent element possesses different light reflection characteristics to its surroundings and particularly reflects light in fewer directions as compared with the lens array 12 (which will tend to scatter light in all directions and hence appear relatively matte). Thus, the latent element appears relatively “glossy” compared to the lens array and, as the device is tilted, will tend to reflect incident light brightly (compared to the lens regions) to the observer at certain angles of view. At other angles of view, the latent element will be substantially invisible. Thus, the visibility of the element varies as the device is tilted yet overall the element does not have a significant visual impact on the device. As in the case of the tactile elements, the latent elements are preferably also substantially transparent and most preferably colourless.

In preferred embodiments, these reflection characteristics are achieved by configuring the latent element(s) such that they are smoother than the surface of the lens array—i.e. any height variation of the latent element(s) has a lower spatial frequency in at least one direction than that of the lens array.

Like tactile elements, providing such latent features in registration with the lenses poses a significant challenge to counterfeiters. It should be noted that the tactile elements already described may additionally possess latent characteristics. For instance, in FIG. 2, if the surface 16a of the substrate 16 is relatively glossy as compared with the lens array, the negative tactile element 18 will also act as a latent element. In the FIG. 4 embodiment, the tactility of element 18 is reduced by depositing material to substantially the same height as the lenses. Thus, each element 18, 19 may be only tactile, or only latent, or both.

In the FIG. 4 embodiment, the lenses are laid down in one printed working and the material forming elements 18 and 19 is laid down in another working. Here, the lens working includes gaps in which the lenses are omitted corresponding to the areas in which elements 18 and 19 are to be situated. Hence, the workings could be laid down in either order.

Whichever manner of forming the tactile/latent elements is adopted, no synthetic image of the microimage is formed along the lines 18, 19 (even if the microimage array is continuous across the areas containing the elements), since no operational lenses are present. This may be due to their omission (e.g. elements 18 and 19 in FIGS. 2 and 4, and element 18 in FIG. 3), or due to the deposition of material on top of the lenses (element 19 in FIG. 3). Even where the material forming the tactile/latent element is transparent, unless there is a significant difference in the refractive indices of the materials, the operative shape of the lenses will be destroyed. Hence, the tactile/latent elements will appear as “gaps” in the visual effect generated by the lens and microimages combination.

Forming the lenses and tactile/latent elements in separate workings provides additional design freedom since different materials can be used for each. This may be desirable, e.g. to introduce a coloured tint to the tactile/latent elements whilst retaining clear (colourless) lenses. This further increases the security level since the counterfeiter must now match the colour of the elements in addition to achieving the necessary tactile and/or latent quality. However, by keeping the lenses substantially colourless, the underlying data and graphics 6, 7, 8 can still be viewed without detriment.

In a particularly preferred embodiment, a similar result is achieved whilst allowing the lenses and tactile/latent elements to be formed in a single working, by providing the material forming the lenses and elements with a colourant substance at a concentration at which the lenses will appear substantially colourless whilst a coloured tint will be apparent in (positive) tactile elements, due to the greater volume of deposited material. For example, a suitable material for forming both the lenses and tactile elements with this result is a transparent UV curable resin (any of the types mentioned above), to which is added 5% by weight of Omniplus UL from Sericol, which is a coloured UV curable ink.

Alternatively, the material forming the lenses (and, optionally, the tactile/latent elements) may be provided with a higher colour concentration, such that the lenses possess a detectable coloured tint. In this case it is particularly preferable if the colour of the tint is selected to be complementary to any colour conveyed by the microimages. For example, if the microimages are blue it is preferable if the lens tint is yellow. Subtractive colour mixing takes place causing the microimages to appear darker, thereby increasing the apparent contrast in the generated synthetic images.

In the above embodiments, the tactile or latent elements are located along boundaries between regions in which the synthetic images produced by the lenses and microimages are different, e.g. in terms of the subject matter of the images themselves or in terms of their magnification level or image plane position. In this way, a misplaced tactile or latent element will be readily apparent since it will not coincide with the change from one synthetic image type to the next, and this juncture will be visible to one side of the tactile or latent element. Hence a counterfeit device can be readily distinguished from a genuine one.

The same result can be achieved by locating the tactile or latent elements in different positions, although preferably there is a clear relationship between the elements and a uniquely identifiable location of the lens-based feature. FIGS. 5 to 11 show further embodiments of security devices in accordance with the invention to illustrate some alternative designs. In each of these Figures, only the appearance of the security device in plan view is shown and it will be appreciated that in practice data or graphics from an underlying object (e.g. layer 5 in the previous embodiments) will typically also be visible through the security device. The security devices shown can be incorporated into or onto a security document, such as card 1, in the same way as described above in relation to device 10.

FIG. 5 shows a fourth embodiment of a security device 30, having a first region 31 in which there are no lenses and/or no microimages, such that no synthetic image is generated in this region. Second, third and fourth regions 32, 34 and 36 are provided in the shapes of the letters “D”, “L” and “R” respectively. Within each region 32, 34 and 36, lenses and microimages are provided as described above to form synthetic images, here of the letters “D”, “L” and “R” respectively. In this example, the image generating mechanism is a moiré magnifier and so the images of the letters appear on planes which may appear to be located in front of or behind the plane of the device. Each of the regions 32, 24 and 36 is bounded by a tactile element 33, 35 and 37, formed using any of the methods described above. Preferably, if there are no lenses in the region 31, the elements are positive tactile elements in order that their lateral extent is well defined on both sides. Thus the elements 33, 35, 37 each define a boundary between two regions of the device in the same way as in FIG. 1, but in this case in one of the adjacent regions, there is no synthetic image generated (region 31). Hence the elements 33, 35, 37 effectively define the periphery of the optically variable regions 32, 34, 36. If the elements are not correctly registered to the boundaries, this will be readily apparent.

The FIG. 5 embodiment further includes four additional tactile elements 38, here in the shape of a logo. Again, if there are no lenses in region 31, the elements 38 are preferably positive tactile elements. The elements 38 do not directly coincide with or sit adjacent to any of the optically variable regions 32, 34, 36, but are registered to the lenses and/or microimage array as before such that any misplacement of the elements will be noticeable.

FIG. 6 shows a fifth embodiment of a security device 40 with four regions 41, 42, 44 and 46 laid out in substantially the same manner as the regions in FIG. 5. In this case however, region 41 is provided with lenses and microimages such that a synthetic image is formed, as represented by the pattern of circles shown. This may be a moiré magnifier effect or a lenticular effect, for example. Again, tactile or latent elements 43, 45 and 47 are provided at the boundaries between regions 41, 42, 44 and 46 and these may be positive or negative (or of the same height as the lenses if no tactility is desired).

In addition, the device 40 is provided with two elliptical regions 48 which overlay region 41. Each region 48 has a set of closely spaced, parallel, raised tactile lines which produce a repeating sensation as the user passes their finger or fingernail over them. Within each elliptical region 48, a latent element 49 is provided, here in the shape of a star. The elements 49 may be formed by applying material over the top of the tactile lines (e.g. in a third working), or could be formed by gaps in the working in which the tactile lines are laid down. In this latter case, preferably the lenses are also absent in the areas corresponding to the star-shaped regions 49 in order to utilise the glossy surface of the underlying substrate to maximise the difference in reflective appearance between the regions 48 and 49. If the lenses are formed right up to the boundary with the star-shaped regions 49, any misregister between the tactile regions 48 defining star-shaped regions 49 and the lenses will be apparent since the lenses will extend into the star-shaped gaps in elliptical regions 49 and these will not appear glossy, or a boundary will be visible. Hence counterfeit devices can be readily detected.

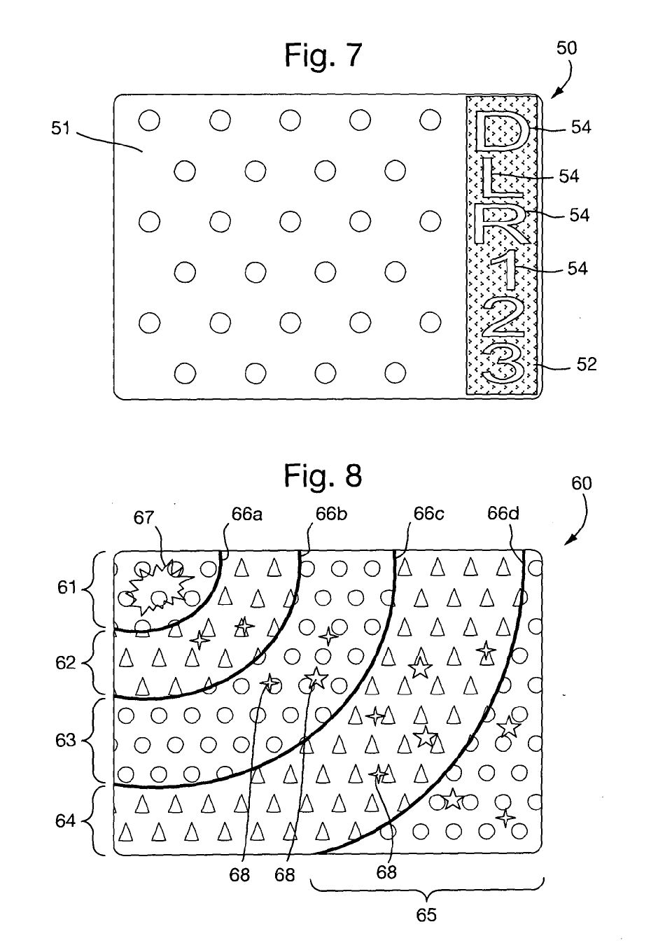

FIG. 7 shows a sixth embodiment of a security device 50 having a region 51 in which lenses and microimages are provided as described above to generate a synthetic image represented by the pattern of circles shown. Along one side, a strip-shaped region 52 is provided with a raised tactile pattern, e.g. a grid of raised dot elements. Within the tactile strip 52 are latent elements 54 in the shape of the letters “D”, “L” and “R” and the numbers “1”, “2”, “3”, defined by the absence of tactile features. Preferably, there are no lenses in the areas corresponding to elements 54 so that the glossy surface of the substrate is revealed. The elements 54 may be detectable by touch (i.e. negative tactile elements) but this is not essential. For example, the line width of each region 54 may be so narrow that its presence cannot be felt. However, the elements 54 will contrast strongly against the tactile (and therefore matte) region 52 when the device is tilted, due to the lesser light scattering effect of the glossy substrate.

FIG. 8 shows a seventh embodiment of a security device 60 having five regions 61, 62, 63, 64 and 65 with lenses and microimages provided in each as described above to generate synthetic images in each region. The appearance of the regions alternates across the device, with regions 61, 63 and 65 exhibiting a magnified pattern of circles, and regions 62 and 64 displaying a magnified pattern of triangles. The apparent position of the image plane on which the images are displayed also varies between regions, with that in regions 61, 63 and 65 appearing to “float” in front of the plane of the device and that in regions 62 and 64 appearing to be located behind the plane of the device such that the “float” and “depth” effects alternate across the device. The apparent position of the image plane can be controlled for a moiré magnifier by adjusting the degree of mismatch between the lens array and the microimage array.

Tactile and/or latent elements 66a, 66b, 66c and 66d are provided along each of the boundaries between the regions 61, 62, 63, 64 and 65. These may be positive or negative tactile elements (or a mixture of the two), or latent elements of the same height as the lenses. Any misregistration between the elements 66 and the lenses will be readily apparent. Additional tactile elements 67 and 68 may be provided within some or all of the regions, which here take various star shapes. Elements 67 and 68 are preferably positive tactile elements formed of a transparent material such that they have minimal visual impact on the device, appearing as gaps in the synthetic image.

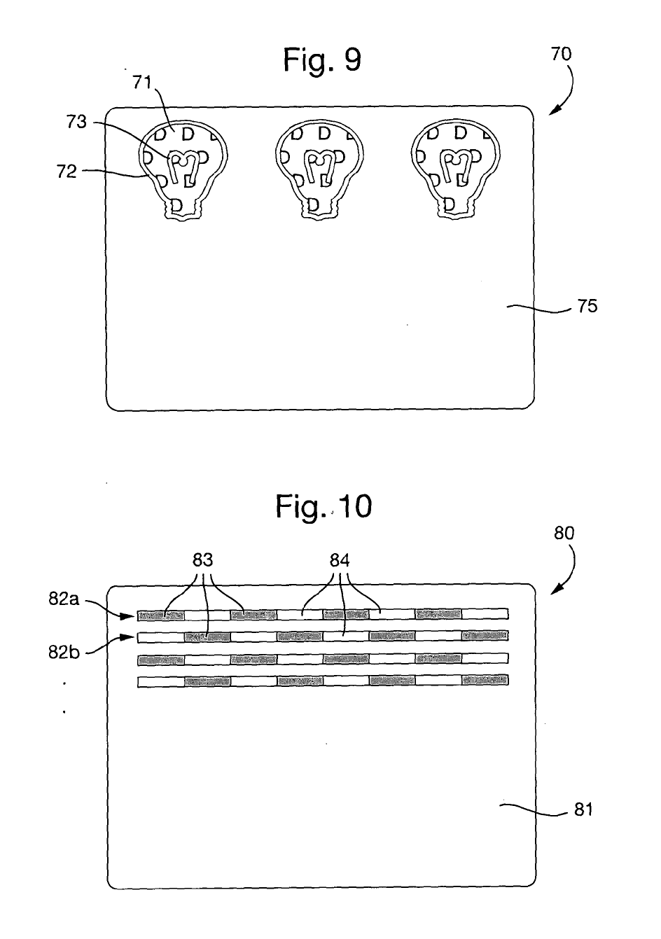

FIG. 9 shows an eighth embodiment of a security element 70 comprising three optically variable regions of which one is labelled 71, surrounded by a region 75 with no lenses and/or microimages. Each of the regions 71 has the shape of a light bulb symbol and exhibits a synthetic image such as an array of the letter “D”. The region 71 is bounded by a tactile element 72 and contains within it a second tactile or latent element 73 denoting the filament of the bulb. This may be a positive or negative element, and preferably appears as a gap in the synthetic image. Any misregistration will be readily apparent.

FIG. 10 shows a ninth embodiment of a security device 80 comprising a region 81 extending over most of the device in which no lenses and/or microimages are present. A series of linear features 82a, 82b etc are provided, each made up of alternating linear regions where 83 denotes tactile and/or latent elements, and 84 denotes regions containing lenses and microimages, displaying a synthetic image (not shown). The tactile/latent elements 83 are shown in grey for clarity but, as with the previous embodiments will typically be at least semi-transparent. The linear arrangement of the elements 83 clearly defines each end of each elongate region 84 displaying the synthetic images such that the intended location of the regions 84 is unambiguous: the tactility is a clear continuation of the optical effect (and vice versa). In addition, the regular pattern of spaced tactile regions gives rise to a repeating sensation as the user moves their finger or finger nail across the device.

Due to the relatively small size of the elongate regions 84 in the FIG. 10 embodiment, rather than utilise a moiré magnification effect, a lenticular device is preferred, utilising two sets of differently coloured microimages for instance. In one example, when viewed from the normal position, the lenses in each region 84 may focus a first colour of microimages toward the viewer such that each region exhibits the first colour (e.g. solid red). When the device is tilted, the lenses may focus a second colour of microimages toward the viewer so that each region appears to switch from the first colour to the second (e.g. solid blue). In a preferred variant, the tactile elements 83 may have a coloured tint or could have a substantially opaque colour, the hue of which substantially matches one of the colours which the regions 84 are equipped to exhibit. Thus, when the device is tilted to certain angles, the lines 82a, 82b etc appear continuous whilst at other angles the lines appear dashed (as shown in FIG. 10).

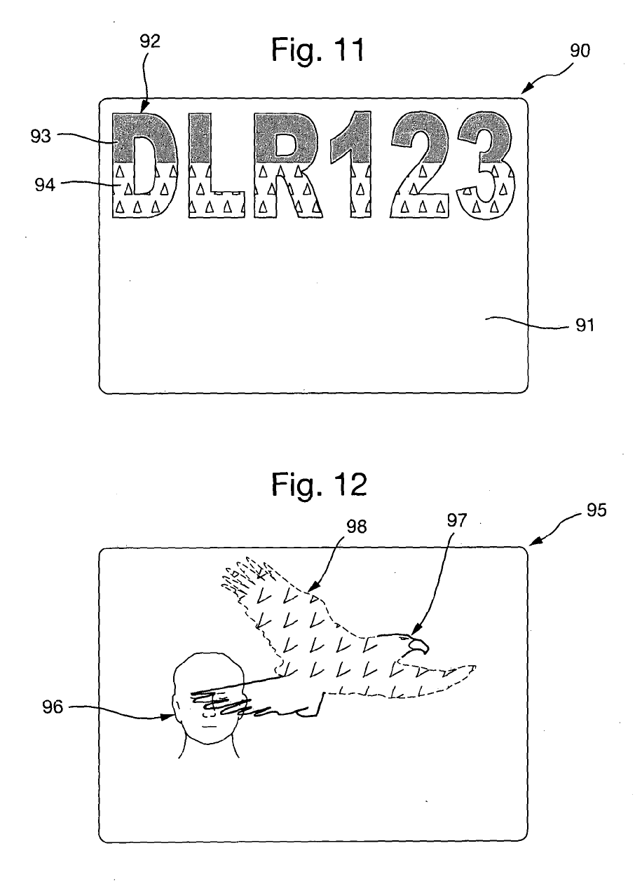

FIG. 11 shows another example of a security device 90 in which tactile and/or latent elements are used to identify the positions at which synthetic images formed by lenses and microimages in combination are expected to be viewed. Here, the device 90 is provided with six items of information 92, here the letters and numbers “D”, “L”, “R”, “1”, “2” and “3”. Each item 92 is formed of a tactile/latent element 93 and a region 94 in which lenses and microimages are provided to give rise to a synthetic image. As in previous embodiments, the tactile/latent elements 93 are depicted in grey but more typically will be at least semi-transparent. Each element 93 denotes a portion (e.g. half) of the item of information 92, with the corresponding regions 94 completing the items. Any misplacement of the tactile/latent elements 93 relative to the regions 94 will be immediately apparent since each letter and number will appear disjointed. Of course, any recognisable item of information such as a logo, shape or symbol could be utilised in place of letters and numbers. The surrounding region 91 in this example has no lenses and/or microimages such that no synthetic image is displayed.

FIG. 12 shows a further embodiment of a device 95 overlying graphics such as photograph 96 on an underneath layer (such as layer 5 of FIG. 1). The security device 97 is provided with tactile and/or latent elements 97 forming part of an image or symbol. In this case, the tactile and/or latent elements 97 form an outline of the head and tail of a bird. Between the head and tail, no tactile/latent elements are provided and the body of the bird is instead represented by a region 98 in which an array of lenses is present, along with corresponding microimages, such that a synthetic image is generated. In this example, the synthetic image is of “V” shapes to represent the bird's feathers. The tactile/latent elements 97 are registered to the region 98 and combine to form the recognisable shape of the bird. Any misregistration between the tactile/latent elements 97 and the region 98 will be readily apparent to a person handling the device, thus rendering counterfeits readily detectable. Meanwhile, only tactile/latent portions of the bird device are coincident with the underlying data (photograph 96). As discussed above, the tactile/latent elements 97 are preferably substantially transparent such that the viewer's perception of the underlying photographic will not be significantly diminished by the security device.

FIG. 13 depicts an example of suitable apparatus 100 for manufacturing security devices in accordance with any of the above embodiments. A substrate web 16 is conveyed by a transport assembly (represented by rollers 101) through a series of stations 102, 104, 106, which could be provided in any order along the transport path. Station 102 is a printing station for applying the array of lenses 12 to the first side 16a of substrate 16, e.g. by screen printing, ink jet printing or flexographic printing of a suitable transparent material. As described with reference to FIG. 2, in the same printing step, tactile and/or latent elements (such as 18 and 19) may be formed, either by omitting lenses across a defined area (to form a negative tactile element) and/or by laying down areas of greater height than the lenses (to form a positive tactile element), using the same material as that which forms the lenses. If all of the tactile/latent elements are formed in this same working, a second station 104 may not be required.

FIG. 14 is a flow diagram illustrating manufacturing steps involved in an exemplary method of this sort. In step S11, the lenses and tactile/latent elements are printed onto the substrate 16 in one working, e.g. by station 102. Then, microimages are applied to the substrate 16 in step S12, e.g. by station 106 as described further below. The order of steps S11 and S12 could be reversed or the steps could be carried out simultaneously.

However, as described with reference to FIGS. 3 and 4, in some cases it is preferred to apply the lenses and tactile/latent elements in separate workings and in this case the tactile/latent elements may be applied by second station 104. This may also be a printing station, not necessarily of the same type as station 102), but preferably applies the tactile/latent elements using the same printing technique as that used at station 102 to apply the lenses (e.g. screen printing, ink jet printing or flexographic printing). By forming the lenses and tactile/latent elements in sequential steps in an in-line process (i.e. during the same print run) in this way, high registration between the lenses and elements can be achieved. Where the lenses and tactile/latent elements are applied in two workings, different materials may be used for each. For instance, station 102 may be supplied with clear material for formation of the lenses, whilst station 104 may be supplied with a tinted material for forming the tactile/latent elements.

FIG. 15 is a flow diagram illustrating steps involved in an exemplary method of this sort. In step S21, the lenses are printed onto the substrate 16, e.g. by station 102. In step S22, the tactile/latent elements are formed on the same side of the substrate 16, e.g. by station 104. In step S23, the microimages are formed on the substrate, e.g. by station 106, described below. However, steps S21, S22 and S23 could be performed in any order and step S23 may be simultaneous with step S21 or step S22.

Station 106 is for forming the microimages and in this example the station is located on the opposite side of the transport path from stations 102 and 104, in order to apply the microimages to the second surface 16 of substrate 16. However in other examples (see FIG. 4), the microimages may be formed on the first surface and in this case station 106 would be arranged upstream of station 102. By forming the microimages in the same in-line process as the lenses and the tactile/latent elements, good registration is achieved. For optimum registration between the microimages and lenses, the station 106 is preferably located opposite station 102 such that the microimages and lenses are applied simultaneously to the opposite sides of substrate 16. However, in other cases, the microimages could be formed in a separate process and optionally on a separate layer such as layer 5 shown in FIG. 2. This layer would then be joined to the substrate 16 such that the microimages sit adjacent the opposite surface of the substrate 16 to that carrying the lenses and tactile or latent elements, preferably in a registered process. Any marking technique can be used to form the microimages, including printing techniques such as offset printing, gravure printing etc., metallisation and laser marking.

Once the lenses, tactile/latent elements and optionally the microimages have been applied to substrate 16, the security device structure may be incorporated directly into a security document web (e.g. applied to a sheet material ultimately forming data/graphics layer 5), before the assembly is cut into individual documents. Alternatively, the security device structure may be cut into individual security devices for later application to security documents or other objects. The security device structure may be formed into security articles such as labels, cover films, strips or security threads using well known techniques. Such articles can then be incorporated into security documents or other objects, e.g. embedded within a windowed banknote, or applied thereto, e.g. adhered to a page of a passport.

FIGS. 16 and 17 depict a further embodiment of a security document, which includes an exemplary security device assembly provided with a region of substantially uniform appearance for enhancing the appearance of the synthetic images generated by an array of lenses in an area of the device, as discussed briefly in connection with FIGS. 1 to 4, above.

This concept can be employed independently of the tactile and/or latent effects described in the previous embodiments. FIGS. 16 and 17 show an exemplary embodiment of a security document 200 of similar construction to that described with respect to FIG. 1, except here the lens array 212 and microimage array 214 forming part of the security device 205 are continuous across the device such that synthetic images 206, 208 of the same general type (e.g. same shape and size) are generated across the device (although this is not essential). In this example, no tactile or latent elements of the sort discussed above are provided although, as discussed with respect to FIG. 1, such elements may be provided.

Information, patterns and other graphics formed by graphics layer 201 on layer 202 (which may be for example a paper or card layer, or formed of a suitable polymer such as Teslin™) are visible through the device 205. Typically, the graphics layer 201 may include security prints such as guilloches, microtext, repeating geometric patterns and/or other fine line patterns to increase the difficulty of counterfeiting. The synthetic images 206 generated by the security device appear superimposed on the graphics of the graphics layer 201. However, the images 206 may appear relatively indistinct and not especially dominant, and this is due at least in part to the lens array additionally picking up parts of the graphics layer 201 (which lie approximately in the same plane as the microimages 214 once the document is assembled) and incorporating such parts into the synthetic images 206. The result is distracting to the eye and diminishes the appearance of the synthetic images 206. In practice, this may in fact be beneficial since the synthetic images 206 do not overly detract from easy inspection of the underlying graphics layer 201, which as explained above will typically include data such as the holder's photograph which it is necessary to view during use of the card.

To address this however, the present embodiment includes a region 204 of substantially uniform appearance underlying the microimages 214. This acts as a background for the synthetic images, removing distracting visual elements which would otherwise be present within the region. As a result, in the portion of the device across which region 204 extends, the appearance of the synthetic images 208 is enhanced relative to the synthetic images 206 in other areas of the device. That is, for example, the contrast between the synthetic images 208 and their surroundings is greater. This is in particular due to the lack of image elements adjacent the microimages 214 of a similar dimension to the microimages 214, as might typically be found on graphics layers with security printing, e.g. fine line patterns or microtext.

The uniform region 204 can take any shape and any location in the security device assembly (comprising security device 205 and graphics layer 201), but does not extend across its full area since areas of the graphics layer 201 must remain visible. In preferred cases, the region 201 may be bounded by graphics of the graphics layer and edges of the security device (as shown in FIGS. 1 and 16) for example, or could be bounded on two or more (preferably all) sides by the graphics of the graphics layer, e.g. appearing as a strip or island shaped region.

The uniform region 204 can be formed in various ways including the application of a masking layer 204 as shown in FIG. 17. The layer 204 could be applied onto substrate 210 over the microimage array 214, or onto layer 202 over graphics layer 201 with the same effect. Alternatively, if the microimage array is provided on the same surface of the substrate as the lens array, the masking layer could be provided underneath the microimage array on the same surface, as depicted by item 4′ in FIG. 4. The masking layer could be printed, deposited or otherwise coated onto the appropriate surface and may comprise an ink, film or foil. The region is preferably solid, i.e. applied all over in a continuous manner, but could be formed of a screen if the resolution is sufficiently high so as to give the required uniform appearance.

In other cases, the uniform region 204 could be an integral part of the graphics layer 201. That is, the graphics layer 201 may include a region of substantially uniform appearance via the absence of indicia such as security prints.

Preferably, the uniform region 204 should be of a colour which contrasts with the microimages. For example, where the microimages are formed in a dark colour, a light colour is preferred for the uniform region 204. It has been found particularly advantageous if the uniform region is formed of a reflective, e.g. specularly reflective, material such as metal, alloy or a metallic ink. This produces a bright and striking appearance, drawing the attention of the user to the region.

In particularly preferred examples, the region 204 is formed in register with either the microimage array 214 or with the graphics layer 201.

FIGS. 18 and 19 depict cross-sections through two further embodiments of security documents into which devices of the sorts described above are incorporated. In this case, the security documents 300 and 300′ are polymer banknotes, but the same could be applied to any document having a transparent substrate, including hybrid paper/polymer banknotes.

The security document 300 shown in FIG. 18 comprises a transparent document substrate 301 which carries opacifying coatings 302, 303 on both sides. In this case both coatings are made up of two layers. The opacifying material may be applied for example by printing and may comprise for example an ink containing a pigment such as a white or grey pigment. The opacifying layer(s) provide a background onto which the graphics 304, 305 to be carried by the document can be applied in the usual manner, e.g. security prints, personalisation information etc. A window is formed by omitting the opacifying layer 302 in a region 308a on the first surface of the substrate 301 and the opacifying layer 303 in a region 308b on the second surface of the substrate 301 which at least overlaps with (and preferably aligns with) the region 308a.

Within the window, a security device 310 is provided which can be in accordance with any of the embodiments discussed above. On the first surface of the substrate, an array of printed lenses 312 is provided together with an element 314 which in this example is tactile (having a height greater than that of the lenses) but in other cases could be latent, or could be both tactile and latent. Any combination of tactile and/or latent elements could be provided and could be manufactured using any of the techniques described in the previous embodiments. In this example, a primer layer 315 is provided to improve retention of the printed lens array on the substrate 301 but this is optional.

On the opposite surface of the substrate 301, a microimage array 318 is provided, e.g. by printing. In this example, a primer layer 316 is provided to improve retention of the microimages on the substrate 301 but this is optional. The lenses 312 are configured such that the microimages 318 sit approximately in the focal plane of the lenses. When viewed from the side carrying the lenses, a synthetic image of the microimages is observed as before. As in the preceding embodiments, the tactile/latent element 314 does not significantly alter the visual effect of the device, but is detectable by feel and/or upon tilting the device. It should be noted that the dimensions of the various components are not shown to scale in the Figures and in practice the height of the opacifying layers will not protrude beyond that of the lens array and/or tactile element.

In a variant of this embodiment, the microimage array 318 could be formed from the opacifying coating 303 itself. For instance, regions of the coating 303 could be omitted or laid down and then removed to define either positive or negative microimages in the region 308b.

The device 310 could also be a device as described with respect to FIGS. 16 and 17 above, that is to say with no latent or tactile element but with the addition of a uniform region inserted between the microimages and an underlying graphics layer (not shown). In this case the opacifying layer 303 could be continued over a partial area of the microimage array 318 to provide the uniform region.

The security document 300′ shown in FIG. 19 is similar to that of FIG. 18, and like reference numbers denote like components which will not be described again. In this case, the device 310 is provided in a “half-window” region formed by a gap 308c in opacifying layer 302 which is not aligned with any gap in the opacifying layer 303 on the other side of the substrate 301. Hence the opacifying layer 303 continues over the microimage array 318 as denoted by the item 308d.

It should be noted that in both the FIG. 18 and FIG. 19 embodiments, neither the printed lens array nor the microimages are required to be in register with the opacifying coating layers, although this is preferred.

1-95. (canceled)

96. A security device assembly comprising:
a security device comprising an array of lenses arranged on a first surface of a substrate and a microimage array underlying the array of lenses, whereby a synthetic image of portions of the microimages is generated by the lenses;
a graphics layer underlying the security device, the microimage array being disposed between the array of lenses and the graphics layer such that the graphics of the graphics layer and the synthetic image generated by the array of lenses are viewable from the same side of the security device assembly; and
a region of substantially uniform appearance underlying the microimage array across a portion and not the whole of the security device, the region being formed by a masking layer applied between the microimage array and the graphics layer, or by an area of the graphics layer carrying no graphics.

97. A security device assembly according to claim 96, wherein the region of substantially uniform appearance comprises a reflective material, preferably a specularly reflective material, in the form of a masking layer or forming part of the graphics layer.

98. A security device assembly according to claim 96, wherein the region of substantially uniform appearance comprising a masking layer is printed, deposited or otherwise coated onto the microimage array and/or onto the graphics layer.

99. A security device assembly according to claim 96, wherein the region of substantially uniform appearance comprises ink.

100. A security device assembly according to claim 96, wherein the region of substantially uniform appearance is bounded by graphics of the graphics layer and, optionally, edges of the security device assembly.

101. A security device assembly according to claim 96, wherein the region of substantially uniform appearance is bounded on all sides by graphics of the graphics layer.

102. A security device assembly according to claim 96, wherein the graphics of the graphics layer include any of: security prints, guilloches, microtext, or repeating geometric patterns.

103. A security device according to claim 96, wherein the microimage array is provided on the first or second surface of the substrate, or on a further layer adjacent the second surface of the substrate.

104. A security device comprising an array of printed lenses arranged on a first surface of a substrate and a microimage array underlying the array of printed lenses, whereby a synthetic image of portions of the microimages is generated by the lenses, the security device further comprising at least one element arranged on the first surface of the substrate and being registered to the array of printed lenses and/or to the microimage array, wherein the at least one element is at least one of:
a tactile element of greater or lesser height than the printed lenses; or
a latent element which scatters incident light in fewer directions than the printed lenses, such that the visibility of the at least one latent element varies as the device is tilted.

105. A security device according to claim 104, wherein the at least one element comprises an area of the substrate in which no operative printed lenses are present.

106. A security device according to claim 104, wherein the at least one element comprises an area of the substrate in which the printed lenses are absent, which area is defined on at least two sides by the array of printed lenses.

107. A security device according to claim 104, wherein the at least one element is a tactile element and comprises an area of the substrate on which is disposed material, the height of which defines the height of the tactile element.

108. A security device according to claim 104, wherein the at least one element is a printed element, preferably deposited by means of the same printing technique as that by which the array of lenses is printed, the array of printed lenses forming part of a printed lens working and the at least one printed element forming part of a printed element working.

109. A security device according to claim 104, wherein the at least one element is a tactile element and has a height which differs from that of the lenses by at least 5 microns.

110. A security device according to claim 104, wherein the array of lenses and microimage array are configured such that in a first region of the device, a first synthetic image is generated and in a second region of the device, laterally offset from the first region, a different visual appearance is exhibited, one of the at least one element being disposed at a boundary between the first and second regions.

111. A security device according to claim 110, wherein the at least one element is elongate and disposed along at least a portion of the boundary between the first and second regions, preferably along the full length of the boundary.

112. A security device according to claim 110, wherein in the second region, there are no lenses and/or no microimages, such that no synthetic image is generated, whereby the at least one tactile element defines the perimeter of the region generating the first synthetic image.

113. A security device according to claim 110, wherein in the second region, the array of lenses and/or the microimage array is different from those in the first region, such that a second synthetic image is generated, different from the first synthetic image.

114. A security device according to claim 113, wherein the array of lenses and the microimage array are configured such that the first and second synthetic images are generated on different image planes.

115. A security device according to claim 114, wherein the array of lenses and the microimage array are configured such that the first synthetic image is generated on an image plane which appears to the observer to be located behind the array of lenses, and the second synthetic image is generated on an image plane which appears to the observer to be located in front of the array of lenses.

116. A security device according to claim 104, wherein the at least one element is substantially transparent.

117. A security device according to claim 116, wherein the at least one element is formed by transparent material disposed on an area of the substrate, the printed lenses and the material forming the at least one element.

118. A security device according to claim 104, wherein the at least one element is a latent element and, at at least one viewing angle, the at least one latent element appears brighter than the array of printed lenses.

119. A security device according to claim 104, wherein the at least one element is a latent element and the at least one latent element is smooth relative to the array of printed lenses.

120. A security device according to claim 104, wherein the at least one element is a latent element and comprises an area of the substrate in which the printed lenses are absent, which area is defined on at least two sides by the array of printed lenses, the first surface of the substrate being glossy relative to the array of printed lenses.

121. A security device according to claim 104, wherein the at least one element is a latent element and comprises an area of the substrate on which is disposed material which is glossy relative to the array of printed lenses.

122. A security device according to claim 104, wherein the at least one element is a latent element and has a height which is greater or lesser than the height of the printed lenses, such that the at least one latent element is tactile.

123. A plurality of security devices each in accordance with claim 103, wherein the synthetic image and the at least one element have substantially the same positions relative to one another in each of the plurality of security devices at least when the devices are viewed from the normal.

124. A method of manufacturing a security device, comprising, in any order:
providing an array of microimages on a substrate;
printing an array of lenses onto a first surface of the substrate such that when the array of microimages is viewed through the array of lenses, a synthetic image of portions of the microimages is generated; and
forming in registration with the array of lenses and/or with the microimage array at least one element on the first surface of the substrate, the at least one element being at least one of:
a tactile element of greater or lesser height than the printed lenses; or
a latent element which scatters incident light in fewer directions than the printed lenses, such that the visibility of the at least one latent element varies as the device is tilted.

125. A security article comprising a security device or a security device assembly according to claim 1 wherein the security article is at least one of a label, cover film, patch, foil, security strip or security thread.

126. A security document comprising a security device or a security device assembly according to claim 1, wherein the security document is at least one of a bank note, passport, ID card, drivers' license, visa, or certificate.

127. A security document according to claim 126, wherein the security document is of a multilayered construction, the substrate forming an integral layer of the document, at least the first surface of the substrate carrying the array of lenses being an outermost surface of the security document.
